(19) United States
(12) Patent Application Publication
(10) Pub. No.: US 2024/0188197 A1
(43) Pub. Date: Jun. 6, 2024

(54) INDUCTION ENERGY TRANSMISSION SYSTEM

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/285,658

(22) PCT Filed: Apr. 5, 2022
(86) PCT No.: PCT/EP2022/058963

§ 371 Date: Oct. 5, 2023

(30) Foreign Application Priority Data
May 19, 2021 (EP) 21382334

(51) Int. Cl. H05B 6/12; H05B 6/06

(52) U.S. Cl. CPC H05B 6/1236; H05B 6/065; H05B 2213/06

(57) ABSTRACT

An induction energy transmission system includes a support plate, a supply unit arranged below the support plate and including a supply induction element for inductively providing energy, a household appliance designed for placement on the support plate and including a receiving induction element designed to receive the inductively provided energy, and a control unit designed to control the supply unit and to identify automatically the household appliance placed on the support plate.

The invention relates to an induction energy transmission system, in particular an induction cooking system, according to the preamble of claim 1 and a method for operating an induction energy transmission system according to the preamble of claim 13.

Induction energy transmission systems are already known from the prior art for the inductive transmission of energy from a primary coil of a supply unit to a secondary coil of a small household appliance. For example, an induction cooktop which, in addition to inductively heating cookware, is also provided for supplying energy to small household appliances, for example a blender, is proposed in the publication U.S. Pat. No. 3,761,668 A. Energy which is inductively provided by a primary coil of the induction cooktop is partially transmitted to a secondary coil integrated in the small household appliance.

In view of the many types of small household appliances available on the market, which in some cases have very different maximum powers and different numbers of power levels, initially the problem for the user is to establish whether a specific small household appliance is even suitable for being supplied with energy by a specific supply unit, for example a supply unit of an induction cooktop. If the small household appliance is suitable for being supplied with energy by a corresponding supply unit, this also results in the problem of adapting a power which is inductively provided by the supply unit. In particular, in the case of small household appliances with a low maximum power, it can rapidly lead to an oversupply, for example in the form of voltage peaks and thus to damage to the small household appliance. In order to prevent this, the user has to adapt the power very accurately or a control unit for controlling the supply unit initially has to be configured individually for an operation for supplying power to a specific small household appliance, resulting in the drawback that the ease of use is impaired for the user.

The object of the invention, in particular but not limited thereto, is to provide a generic system having improved properties regarding the ease of use for a user. The object is achieved according to the invention by the features of claims 1 and 13, while advantageous embodiments and developments of the invention can be found in the dependent claims.

The invention is based on an induction energy transmission system, in particular an induction cooking system, comprising a support plate, comprising a supply unit that is arranged below the support plate and has at least one supply induction element for inductively providing energy, further comprising a control unit for controlling the supply unit and comprising at least one small household appliance to be placed on the support plate, wherein the small household appliance has at least one receiving induction element for receiving the inductively provided energy.

It is proposed that the control unit is provided to identify automatically the small household appliance placed on the support plate.

An induction energy transmission system can be advantageously provided with a particularly high degree of ease of use for the user by means of such an embodiment. In particular, a simpler, more rapid and safer operation of the small household appliance on the support plate can be made possible by the control unit being provided to identify automatically the small household appliance placed on the support plate, since manual settings for regulating the power and/or for configuring the control unit for operating the small household appliance can be advantageously dispensed with. In particular, it is advantageously possible to prevent damage to the small household appliance by too great a quantity of energy being inductively provided. Moreover, an accidental operation of unsuitable small household appliances, resulting in risks to a user, for example a fire hazard, can be effectively prevented by the control unit automatically identifying the small household appliance and thus advantageously an induction energy transmission system can be provided with a particularly high degree of safety. Thus a plurality of different small household appliances can be put into operation particularly simply and rapidly and can be supplied with the energy which is inductively provided by the supply unit on the basis of their individual energy requirement.

The induction energy transmission system has at least one main functionality in the form of a wireless energy transmission, in particular in a wireless energy supply of small household appliances. In one advantageous embodiment, the induction energy transmission system is configured as an induction cooking system with at least one further main function deviating from a pure cooking function, in particular at least one energy supply and operation of small household appliances. For example, the induction energy transmission system could be configured as an induction oven system and/or as an induction grill system. In particular, the supply unit could be configured as part of an induction oven and/or as part of an induction grill. Preferably, the induction energy transmission system which is configured as an induction cooking system is configured as an induction cooktop system. The supply unit is thus configured, in particular, as part of an induction cooktop. In a further advantageous embodiment, the induction energy transmission system is configured as a kitchen energy supply system and can also be designed to provide cooking functions in addition to a main function in the form of an energy supply and an operation of small household appliances. A “support plate” is intended to be understood to mean at least one, in particular plate-like, unit which is provided for placing at least one small household appliance and/or item of cookware and/or for placing at least one item of food to be cooked. The support plate could be configured, for example, as a countertop, in particular as a kitchen countertop, or as a sub-region of at least one countertop, in particular of at least one kitchen countertop, in particular of the induction energy transmission system. Alternatively or additionally, the support plate could be configured as a cooktop plate. The support plate which is configured as a cooktop plate could form, in particular, at least one part of a cooktop external housing and at least to a large part form the cooktop external housing, in particular, together with at least one external housing unit to which the support plate, which is configured as a cooktop plate, could be connected, in particular, in at least one assembled state. Preferably, the support plate is manufactured from a non-metallic material. The support plate could be formed, for example, at least to a large part from glass and/or from glass ceramic and/or from Neolith and/or from Dekton and/or from wood and/or from marble and/or from stone, in particular from natural stone, and/or from laminate and/or from plastics and/or from ceramic. In the present application, directional terms such as for example “below” or “above” refer to an assembled state of the support plate, provided this is not explicitly described elsewhere.

A “supply unit” is intended to be understood to mean, in particular, a unit which in at least one operating state provides energy inductively and which, in particular, has a main functionality in the form of providing energy. For the provision of energy, the supply unit has at least one supply induction element which has, in particular, at least one coil, in particular at least one primary coil and/or is configured as a coil and which, in particular, in the operating state provides energy inductively. The supply unit could have at least two, in particular at least three, advantageously at least four, particularly advantageously at least five, preferably at least eight and particularly preferably a plurality of supply induction elements which in each case in the operating state could provide energy inductively and namely, in particular, to a single receiving induction element or to at least two or more receiving induction elements of at least one small household appliance and/or at least one further small household appliance. At least some of the supply induction elements could be arranged in the vicinity of one another, for example in a row and/or in the form of a matrix. Preferably, the supply unit has at least one power unit. Preferably, in the operating state the power unit carries out a frequency conversion and converts, in particular, an input-side low frequency AC voltage into an output-side high frequency AC voltage. Preferably, the low frequency AC voltage has a frequency of at most 100 Hz. Preferably, the high frequency AC voltage has a frequency of at least 1000 Hz. The power unit is connected to the control unit and can be controlled by the control unit by means of control signals. Preferably, the power unit is provided to undertake the adjustment of the energy which is inductively provided by the at least one supply induction element, by adjusting the high frequency AC voltage. Preferably, the power unit comprises at least one rectifier. Preferably, the power unit has at least one heating frequency element which is configured, in particular, as an inverter. Preferably, for an operation of the at least one supply induction element the heating frequency element generates an oscillating electrical current, preferably at a frequency of at least 15 kHz, in particular of at least 17 kHz and advantageously of at least 20 kHz. Preferably, the inverter comprises at least two bipolar transistors with an insulated gate electrode and particularly advantageously at least one damping capacitor.

Preferably, the small household appliance is a location-independent household appliance which has at least one receiving induction element and at least one functional unit which in an operating state provides at least one household appliance function. “Location-independent” is intended to be understood to mean in this context that the small household appliance can be freely positioned in a household by a user and, in particular, without the use of tools, in particular in contrast to a large household appliance which is fixedly positioned and/or installed at a specific position in a household, such as for example an oven or a refrigerator. Preferably, the small household appliance is configured as a small kitchen appliance and in the operating state provides at least one household appliance function for processing food. The small household appliance could be configured, for example, without being limited thereto, as a multifunction food processor and/or as a blender and/or as an electric whisk and/or as a grinder and/or as kitchen scales or as a kettle or as a coffee machine or as a rice cooker or a milk frother or as a deep-fat fryer or as a toaster or as a juicer or as a food slicer or the like.

The receiving induction element comprises at least one secondary coil and/or is configured as a secondary coil. In an operating state of the small household appliance, the receiving induction element supplies the functional unit with electrical energy. Moreover, it is conceivable that the small household appliance has an energy storage device, in particular an accumulator, which is provided in a charging state to store electrical energy received by the receiving induction element, and in a discharging state to provide the energy for supplying the functional unit.

A “control unit” is intended to be understood to mean, in particular, an electronic unit which is provided to control and/or to regulate at least the supply unit and to automatically identify the small household appliance placed on the support plate, and which is preferably integrated at least partially in the support plate and/or is arranged below the support plate. Preferably, the control unit comprises a computer unit and, in particular, in addition to the computer unit at least one memory unit which provides at least one temporary memory for the computer unit. The control unit is preferably provided for an automatic object recognition of objects placed and/or positioned on the support plate. The control unit provided for the automatic object recognition in an operating state automatically identifies the presence of an object on the support plate and on the basis of at least one parameter assigns this object to at least one object category. The object categories are preferably stored in a memory unit of the control unit and, without being limited thereto, could contain a first object category of “operating objects” which encompasses all objects which can be inductively supplied with energy by means of the supply unit and in a targeted manner, in particular small household appliances and items of cookware, and a second object category of “foreign objects” which encompasses at least all metallic objects which at least cannot be inductively supplied with energy in a targeted manner by means of the supply unit, for example metallic cutlery. The object recognition by the control unit could take place optically, for example by means of a camera integrated in the support plate. Preferably, the object recognition takes place inductively by means of the supply unit and namely on the basis of at least one change of at least one parameter of a switching circuit of the supply unit, which is electrically conductively connected to the supply induction element, for example on the basis of a changed inductance and/or resonant frequency of the switching circuit. The automatic identification by the control unit of the small household appliance placed on the support plate goes beyond pure object recognition and contains at least one identification of at least one further piece of information. For example, the automatic identification could contain at least one difference between the small household appliance and the item of cookware from the object category of the operating objects. Preferably, the automatic identification beyond the recognition contains at least one further feature of the small household appliance. The feature of the small household appliance can be, without being limited thereto, a classification of small household appliances, for example. Different classifications of small household appliances could be stored in the memory unit and, for example, could be categorized on the basis of a power requirement and/or a number and type of electrical loads to be operated, such as for example purely resistive loads, for example in the case of a kettle or toaster, and inductive and/or capacitive loads, such as for example in the case of household appliances with an electric motor, such as for example blenders and the like, and combinations of the aforementioned load types. The recognition of the at least one further piece of information and/or the further feature of the small household appliance within the context of the automatic identification by the control unit of the small household appliance placed on the support plate could also take place inductively by means of the supply unit and namely on the basis of at least one change of at least one parameter of the switching circuit of the supply unit, which is electrically conductively connected to the supply induction element, for example on the basis of a changed inductance and/or resonant frequency of the switching circuit.

“Provided” is intended to be understood to mean specifically programmed, designed and/or equipped. An object being provided for a specific function is intended to be understood to mean that the object fulfills and/or executes this specific function in at least one use state and/or operating state.

It is further proposed that the induction energy transmission system has a communication interface for wireless data communication, in particular via NFC, between the control unit and the small household appliance. Such an embodiment can advantageously enable a particularly simple and reliable identification of the small household appliance by the control unit. Additionally, an exchange of data can advantageously be made possible between the small household appliance and the control unit which goes beyond a pure identification, for example an exchange of operating states. The communication interface could be provided for wireless data communication via RFID, or via WIFI, or via Bluetooth or via ZigBee or for wireless data communication according to another suitable standard. Preferably, the communication interface is provided for wireless data communication via NFC. As a result, advantageously it is possible to provide a particularly future-proofed induction energy transmission system which is compatible with a plurality of small household appliances.

As described above, the control unit could be provided to the small household appliance inductively by means of the supply unit, for example on the basis of at least one change of at least one parameter of the switching circuit which is electrically conductively connected to the at least one supply induction element. In an advantageous embodiment, however, it is proposed that the control unit is provided to identify the small household appliance on the basis of an identification signal transmitted via the communication interface. As a result, a particularly simple and reliable identification of the small household appliance can be made possible. Additionally, a very accurate identification can be advantageously made possible. In addition to the above-described features, such as for example the classification of small household appliances, the identification signal can comprise more specific information relating to the household appliance, for example also a specific household appliance type, a type number, manufacturing and servicing data, safety instructions or personalized information, such as for example a name of the user or the like.

It is further proposed that the induction energy transmission system has a memory unit in which at least one operating parameter of the small household appliance is stored. The memory unit could be at least partially integrated in the support plate and/or arranged below the support plate. Preferably, the memory unit is at least indirectly connected to the control unit and namely such that the control unit can access the memory unit. The memory unit could be part of the control unit and connected directly thereto. Alternatively or additionally, it is conceivable that the memory unit and/or at least one further memory unit is/are integrated in the small household appliance. In this case, the memory unit and/or the further memory unit is/are preferably connected wirelessly and namely preferably indirectly via the communication unit to the control unit. Preferably, a plurality of operating parameters of the small household appliance and/or a further small household appliance are stored in the memory unit, the operating parameters being able to be assigned to the small household appliance on the basis of the identification signal or the further small household appliance on the basis of a further identification signal, and namely in particular by the control unit. Advantageously, such an embodiment enables a control of the supply unit by the control unit which is individually tailored to the small household appliance.

It is further proposed that the control unit is provided to determine a maximum power of the small household appliance on the basis of the operating parameter. As a result, advantageously a particularly safe and reliable operation of the small household appliance can be achieved. In particular, advantageously an oversupply of the supply unit by an inductively provided energy, which could exceed the maximum power of the small household appliance and thus could cause damage to the small household appliance, can be effectively prevented. Moreover, it is proposed that the control unit is provided to determine a number of power levels of the small household appliance on the basis of the operating parameter. As a result, advantageously a particularly accurate and needs-based energy supply of the small household appliance by the supply unit can be made possible.

It is further proposed that the control unit is provided to calculate a distribution of the maximum power to the number of power levels on the basis of at least one distribution function. Preferably, the distribution function is stored in the memory unit and can be assigned by the control unit to the small household appliance on the basis of the identification signal. The distribution function could be, for example, a linear distribution function, on the basis of which the maximum power of the small household appliance can be distributed by the control unit starting from a lowest power level of the small household appliance, the power thereof corresponding to a quotient of the maximum power and the number of power levels, rising in a linear manner up to a highest power level, the power thereof corresponding to the maximum power. Alternatively or additionally, the distribution function could be a non-linear function, for example a power function or an exponential function, or the like.

As described above, the memory unit could be at least partially integrated in the support plate and/or arranged below the support plate. In an alternative advantageous embodiment, however, it is proposed that the memory unit is integrated in the small household appliance. As a result, advantageously a particularly high level of flexibility can be achieved and advantageously an ease of use for the user can be further enhanced. In particular, new types of small household appliances can be particularly rapidly and easily integrated into the induction energy transmission system when the memory unit is integrated in the small household appliance.

It is further proposed that the control unit is provided to access the memory unit via the communication interface and to request the operating parameter. As a result, advantageously an ease of use for a user can be further enhanced. In particular, new types of small household appliances which have an integrated memory unit can be integrated particularly rapidly and easily into the induction energy transmission system when the control unit is provided to access the memory unit via the communication interface and to request the operating parameter.

It is further proposed that the control unit is provided to control the energy provided by the supply unit on the basis of a current power requirement of the small household appliance. Preferably, the small household appliance transmits the current power requirement to the control unit by means of the communication unit. Alternatively or additionally, however, it might also be conceivable that the induction energy transmission system has an operating unit which is at least partially integrated in the countertop and connected to the control unit for the input of operating commands by a user, wherein a control of the small household appliance on the basis of the operating commands, which contain in particular a current power requirement, could be provided by means of the control unit via the communication interface.

In an advantageous embodiment of the invention, it is proposed that the support plate is configured as a cooktop plate. By means of such an embodiment, an induction energy transmission system which is configured as an induction cooking system can be provided with the aforementioned advantageous properties which, in addition to an inductive energy supply of small household appliances by the supply unit according to the above-described embodiments, also permits an inductive heating of cookware.

In an alternative advantageous embodiment of the invention, it is proposed that the support plate is configured as a kitchen countertop. As a result, an induction energy transmission system can be provided with the aforementioned advantageous properties and with a particularly high level of aesthetics and functionality. Advantageously, an interest in inductive energy transmission can also be enhanced when the support plate is configured as a kitchen countertop, since some components of the induction energy transmission system, in particular the supply unit, can remain entirely unseen by a user below the kitchen countertop, and thus can create the impression that the small household appliance is operated without any energy source. In the case of a support plate configured as a kitchen countertop, the induction energy transmission system could also be configured as an induction cooking system, wherein the supply unit could also be provided for an inductive heating of cookware in addition to an inductive energy supply of small household appliances.

The invention is also based on a method for operating an induction energy transmission system, in particular according to one of the above-described embodiments, comprising a support plate and comprising a supply unit that is arranged below the support plate and has at least one supply induction element for inductively providing energy, and comprising at least one small household appliance to be placed on the support plate, wherein the small household appliance has at least one receiving induction element for receiving the inductively provided energy.

It is proposed that a small household appliance placed on the support plate is automatically identified. Advantageously, such a method can enable a particularly convenient, safe, simple and reliable operation of the induction energy transmission system.

The induction energy transmission system is not intended to be limited to the above-described use and embodiment. In particular, for fulfilling a mode of operation described herein the induction energy transmission system can have a number of individual elements, components and units deviating from a number cited herein.

Further advantages are found in the following description of the drawing. Two exemplary embodiments of the invention are shown in the drawing. The drawing, the description and the claims contain numerous features in combination. The person skilled in the art will expediently consider the features individually and combine them to form further meaningful combinations.

In the drawing

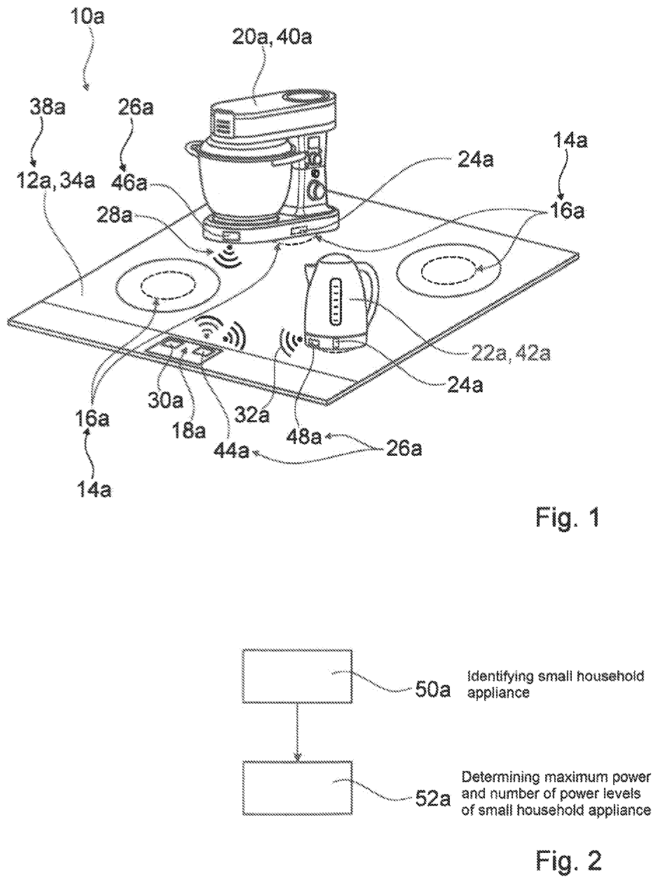

FIG. 1 shows an induction energy transmission system with a support plate, a supply unit, a control unit and two small household appliances placed on the support plate, in a schematic view,

FIG. 2 shows a schematic process flow diagram for illustrating a method for operating an induction energy transmission system and

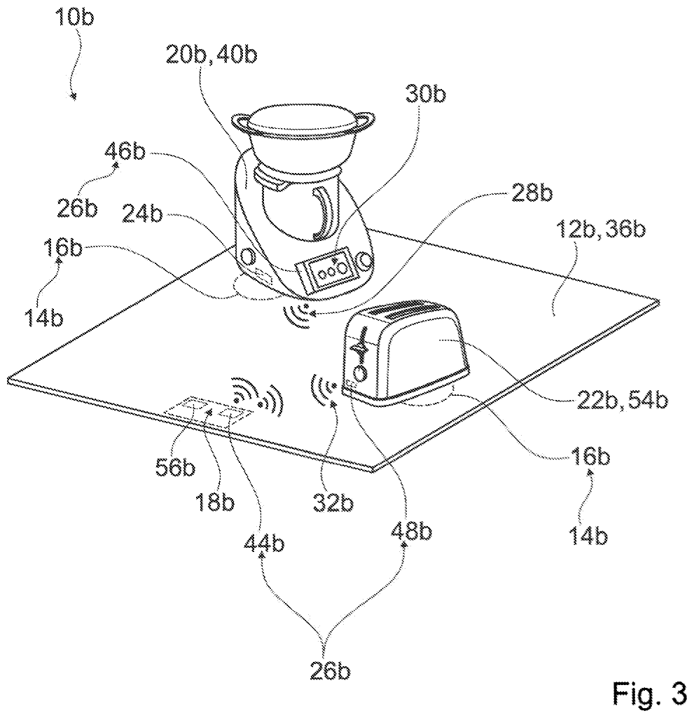

FIG. 3 shows a further exemplary embodiment of an induction energy transmission system with a support plate, a supply unit, a control unit and two small household appliances placed on the support plate in a schematic view.

FIG. 1 shows an induction energy transmission system 10a in a schematic view. The induction energy transmission system 10a has a support plate 12a and a supply unit 14a. The supply unit 14a is arranged below the support plate 12a and has at least one supply induction element 16a for inductively providing energy. In the present case, the supply induction unit 14a has a total of four supply induction elements 16a which are arranged below the support plate 12a. The induction energy transmission system 10a has a control unit 18a for controlling the supply unit 14a.

The induction energy transmission system 10a is configured in the present case as an induction cooking system and comprises an induction cooktop 38a. In the present case, the support plate 12a is configured as a cooktop plate 34a. The cooktop plate 34a is part of the induction cooktop 38a.

The induction energy transmission system 10a comprises at least one small household appliance 20a to be placed on the support plate 12a. The small household appliance 20a has at least one receiving induction element 24a. The receiving induction element 24a is provided for receiving an inductively provided energy. In the present case, the receiving induction element 24a is provided for receiving the energy which is inductively provided by the supply induction element 16a. In the present case, the induction energy transmission system 10a comprises the small household appliance 20a and a further small household appliance 22a. The small household appliance 20a is configured as a food processor 40a and, amongst other things, for blending and/or whisking foodstuffs. The further small household appliance 22a is configured as a kettle 42a.

The control unit 18a is provided to identify automatically the small household appliance 20a placed on the support plate 12a.

The induction energy transmission system 10a has a communication interface 26a for wireless data communication between the control unit 18a and the small household appliance 20a or the further small household appliance 22a. The communication interface 26a has a communication interface element 44a. The communication interface element 44a is connected to the control unit 18a and configured for the wireless transmission and receiving of data. The communication interface 26a has two further communication interface elements 46a, 48a which are configured in each case for the wireless transmission and receiving of data. The further communication interface element 46a is integrated in the small household appliance 20a and provided for wireless data communication between the control unit 18a and the small household appliance 20a. The further communication interface element 48a is integrated in the further small household appliance 22a and provided for wireless data communication between the control unit 18a and the further small household appliance 22a. In the present case, the communication interface 26a is provided for wireless data communication via NFC, and the communication interface element 44a and the further communication interface elements 46a, 48a are configured in each case for transmitting and receiving data via NFC.

The control unit 18a is provided to identify the small household appliance 20a on the basis of an identification signal 28a transmitted via the communication interface 26a. The control unit 18a is also provided to identify the further small household appliance 22a on the basis of a further identification signal 32a transmitted via the communication interface 26a.

The induction energy transmission system 10a also has a memory unit 30a. In the present case, the memory unit 30a is connected to the control unit 18a. At least one operating parameter of the small household appliance 20a is stored in the memory unit 30a. In the present case, a plurality of operating parameters and at least one operating parameter of the small household appliance 20a and at least one operating parameter of the further small household appliance 22a are stored in the memory unit 30a. The operating parameters stored in the memory unit 30a are able to be assigned in each case via the identification signal 28a to the small household appliance 22a and via the further identification signal 32a to the further small household appliance 22a.

The control unit 18a is provided to determine a maximum power of the small household appliance 20a on the basis of the operating parameter. The control unit 18a is also provided to determine a number of power levels of the small household appliance 20a on the basis of the operating parameter. Moreover, in the present case the control unit 18a is also provided to calculate a distribution of the maximum power to the number of power levels on the basis of at least one distribution function.

The small household appliance 20a which is configured as a food processor 40a has, for example, a maximum power of 700 watts and a total number of seven power levels. In an operating state, the control unit 18a calculates the distribution of the maximum power to the number of power levels on the basis of the at least one distribution function. In the simplest case, it might be conceivable that the distribution function is a linear function and the distribution of the maximum power is calculated by the control unit 18a by the maximum power being divided by the number of power levels and the result therefrom in each case being multiplied by a number of the respective power level, in order to obtain the power available at the respective power level. In this case, a first power level is assigned a power of 100 watts, a second level a power of 200 watts, a third level a power of 300 watts, etc. Alternatively or additionally, it might be conceivable that a specific distribution is provided for the small household appliance 20a, for example an exponential distribution of the maximum power to the number of power levels which are stored in the memory unit 30a as a distribution function and assigned to the small household appliance 20a via the identification signal 28a.

The control unit 18a is provided to control the energy provided by the supply unit 14a on the basis of a current power requirement of the small household appliance 20a. In an operating state of the induction energy transmission system 10a, the control unit 18a controls the power which is inductively provided by the supply unit 14a on the basis of the maximum power determined by the operating parameter of the small household appliance 20a, the number of power levels and the distribution of the maximum power, calculated therefrom by means of the distribution function, to the number of power levels. The small household appliance 20a transmits the current power requirement via the communication interface 26a to the control unit 18a, for example in the form of a currently adjusted power level.

FIG. 2 shows a schematic process flow diagram of a method for operating the induction energy transmission system 10a. In the method, the small household appliance 20a which is placed on the support plate 12a is identified (see FIG. 1). The method comprises at least two method steps. In a first method step 50a the small household appliance 20a is identified. To this end, the small household appliance 20a transmits the identification signal 28a via the further communication interface element 46a to the communication interface element 44a and thus to the control unit 18a, wherein the small household appliance 20a is identified on the basis of the identification signal 28a. In a further method step 52a, the maximum power and the number of power levels of the small household appliance 20a are determined on the basis of the operating parameter stored in the memory unit 30a and a distribution of the maximum power to the number of power levels is calculated on the basis of the at least one distribution function. Subsequently, the energy which is inductively provided by the supply unit 14a is controlled on the basis of a current power requirement of the small household appliance 20a.

A further exemplary embodiment of the invention is shown in FIG. 3. The following descriptions are limited substantially to the differences between the exemplary embodiments, wherein relative to components, features and functions remaining the same, reference can be made to the description of the exemplary embodiment of FIGS. 1 and 2. For differentiating between the exemplary embodiments, the letter a in the reference signs of the exemplary embodiment in FIGS. 1 to 2 is replaced by the letter b in the reference signs of the exemplary embodiment of FIG. 3. Relative to components remaining the same, in particular relative to components having the same reference signs, in principle reference can also be made to the drawings and/or the description of the exemplary embodiment of FIGS. 1 to 2.

FIG. 3 shows an induction energy transmission system 10b in a schematic view. The induction energy transmission system 10b has a support plate 12b and a supply unit 14b. The supply unit 14b is arranged below the support plate 12b and has at least one supply induction element 16b for inductively providing energy. In the present case, the supply induction unit 14b comprises a total of two supply induction elements 16b which are arranged below the support plate 12b. The induction energy transmission system 10b has a control unit 18b for controlling the supply unit 14b.

In contrast to the above exemplary embodiment of the induction energy transmission system 10a shown in FIG. 1, the support plate 12b of the induction energy transmission system 10b is configured as a kitchen countertop 36b.

The induction energy transmission system 10b has at least one small household appliance 20b. In the present case, the induction energy transmission system 10b has the small household appliance 20b and a further small household appliance 22b which in each case have a receiving induction element 24b for receiving an inductively provided energy. The small household appliance 20b is configured as a food processor 40b. In contrast to the food processor 40a of the above exemplary embodiment, in addition to blending and/or whisking, the food processor 40b can also be provided for heating food and accordingly has a higher maximum power and a greater number of power levels. In the present exemplary embodiment, the further small household appliance 22b is configured as a toaster 54b.

The induction energy transmission system 10b has a communication interface 26b for wireless data communication between the control unit 18b and the small household appliance 20b and the further small household appliance 22b. The communication interface 26b has a communication interface element 44b which is connected to the control unit 18b and is configured for the wireless transmission and receiving of data. The control unit 18b, the communication interface element 44b and a further memory unit 56b are integrated in each case in the support plate 12b. The communication interface 26b has two further communication interface elements 46b, 48b, which in each case are configured for the wireless transmission and receiving of data. The further communication interface element 46b is integrated in the small household appliance 20b and provided for wireless data communication between the control unit 18b and the small household appliance 20b. The further communication interface element 48b is integrated in the further small household appliance 22b and provided for wireless data communication between the control unit 18b and the further small household appliance 22b. In the present case, the communication interface 26b is provided for wireless data communication via NFC and the communication interface element 44b and the further communication interface elements 46b, 48b are configured in each case for transmitting and receiving data via NFC.

The control unit 18b is provided to identify the small household appliance 20b on the basis of an identification signal 28b transmitted via the communication interface 26b.

The induction energy transmission system 10b has a memory unit 30b. In contrast to the above exemplary embodiment, the memory unit 30b is integrated in the small household appliance 20b. The control unit 18b is provided to access the memory unit 30b via the communication interface 26b and to request an operating parameter of the small household appliance 20b. The control unit 18b is provided to determine on the basis of the operating parameter a maximum power and a number of power levels of the small household appliance 20b. The control unit 18b is also provided to request via the communication interface 26b a distribution function stored in the memory unit 30b and to calculate a distribution of the maximum power to the number of power levels.

The control unit 18b is also provided to identify the further small household appliance 22b on the basis of a further identification signal 32b transmitted via the communication interface 26b. The induction energy transmission system 10b also has the further memory unit 56b which is connected to the control unit 18b and integrated in the support plate 12b. At least one operating parameter of the further small household appliance 22b is stored in the further memory unit 56b, the operating parameter being able to be assigned to the small household appliance 22b by the control unit 18b on the basis the further identification signal 32b. The control unit 18b is provided to determine a maximum power of the further small household appliance 22b on the basis of the operating parameter. The control unit 18b is also provided to determine a number of power levels of the further small household appliance 22b on the basis of the operating parameter. The control unit 18b in the present case is also provided to calculate a distribution of the maximum power to the number of power levels on the basis of at least one distribution function which is stored in the further memory unit 56b and is assigned to the further small household appliance 22b via the further identification identification signal 32b.

The control unit 18b is provided to control the energy provided by the supply unit 14b on the basis of a current power requirement of the small household appliance 20b or on the basis of a current power requirement of the further small household appliance 22b. In an operating state of the induction energy transmission system 10b, the control unit 18b controls the power which is inductively provided by the supply unit 14b on the basis of the maximum power determined by means of the operating parameter of the small household appliance 20b, the number of power levels and the distribution of the maximum power, calculated therefrom by means of the distribution function, to the number of power levels. The small household appliance 20b transmits the current power requirement via the communication interface 26b to the control unit 18b, for example in the form of a currently adjusted power level.

### REFERENCE SIGNS

10 Induction energy transmission system
12 Support plate
14 Supply unit
16 Supply induction element
18 Control unit
20 Small household appliance
22 Further small household appliance
24 Receiving induction element
26 Communication interface
28 Identification signal
30 Memory unit
32 Further identification signal
34 Cooktop plate
36 Kitchen countertop
38 Induction cooktop
40 Food processor
42 Kettle
44 Communication interface element
46 Further communication interface element
48 Further communication interface element
50 Method step
52 Further method step
54 Toaster
56 Further memory unit

1-13. (canceled)

14. An induction energy transmission system, comprising:
a support plate;
a supply unit arranged below the support plate and comprising a supply induction element for inductively providing energy;
a household appliance designed for placement on the support plate and comprising a receiving induction element designed to receive the inductively provided energy; and
a control unit designed to control the supply unit and to identify automatically the household appliance placed on the support plate.

15. The induction energy transmission system of claim 14, constructed in a form of an induction cooking system.

16. The induction energy transmission system of claim 14, further comprising a communication interface designed for wireless data communication between the control unit and the household appliance.

17. The induction energy transmission system of claim 16, wherein the communication interface is designed for wireless data communication via NFC (Near Field Communication) between the control unit and the household appliance.

18. The induction energy transmission system of claim 16, wherein the control unit is designed to identify the household appliance based on an identification signal transmitted via the communication interface.

19. The induction energy transmission system of claim 14, further comprising a memory unit designed to store an operating parameter of the household appliance.

20. The induction energy transmission system of claim 19, wherein the control unit is designed to determine a maximum power of the household appliance based on the operating parameter.

21. The induction energy transmission system of claim 19, wherein the control unit is designed to determine a number of power levels of the household appliance based on the operating parameter.

22. The induction energy transmission system of claim 21, wherein the control unit is designed to calculate a distribution of a maximum power of the household appliance to the number of power levels based on a distribution function.

23. The induction energy transmission system of claim 19, wherein the memory unit is integrated in the household appliance.

24. The induction energy transmission system of claim 19, further comprising a communication interface designed for wireless data communication between the control unit and the household appliance, said control unit being designed to access the memory unit via the communication interface and to request the operating parameter.

25. The induction energy transmission system of claim 14, wherein the control unit is designed to control the energy provided by the supply unit based on a current power requirement of the household appliance.

26. The induction energy transmission system of claim 14, wherein the support plate is designed as a cooktop plate.

27. The induction energy transmission system of claim 14, wherein the support plate is designed as a kitchen countertop.

28. A method for operating an induction energy transmission system which comprises a support plate, a supply unit arranged below the support plate and including a supply induction element for inductively providing energy, a household appliance designed for placement on the support plate and including a receiving induction element designed to receive the inductively provided energy, and a control unit designed to control the supply unit, the method comprising automatically identifying the household appliance placed on the support plate.

29. The method of claim 28, wherein the household appliance is identified based on an identification signal transmitted via a communication interface for wireless data communication between the control unit and the household appliance.

30. The method of claim 28, further comprising storing an operating parameter of the household appliance in a memory unit.

31. The method of claim 30, further comprising determining a maximum power of the household appliance based on the operating parameter.

32. The method of claim 30, further comprising determining a number of power levels of the household appliance based on the operating parameter.

33. The method of claim 32, further comprising calculating a distribution of a maximum power of the household appliance to the number of power levels based on a distribution function.

34. The method of claim 30, further comprising accessing the memory unit via a communication interface to request the operating parameter.

35. The method of claim 28, further comprising controlling the energy provided by the supply unit based on a current power requirement of the household appliance.
